(19) United States
(12) Patent Application Publication
(10) Pub. No.: US 2011/0201409 A1
(43) Pub. Date: Aug. 18, 2011

(54) INTEGRATED GAMING SECURITY MONITOR AND ETHERNET SWITCH

(75) Inventors: Bronislav Paykin, Mentone VIC (AU); Gregory H. Parrott, Reno, NV (US)

(73) Assignee: IGT, Reno, NV (US)

(21) Appl. No.: 12/707,619

(22) Filed: Feb. 17, 2010

(51) Int. Cl. A63F 9/24; A63F 13/00

(52) U.S. Cl. 463/25; 463/30; 463/43; 463/42

(57) ABSTRACT

Some wager gaming machines described herein include a switch that has an internet protocol (IP) address mapping function. The switch may have its own memory for maintaining gaming information, such as security information, state information, configuration parameters, etc. The switch may have embedded security functions that can operate even if a motherboard of the gaming machine is powered off or is otherwise inoperative. The function of the switch may change according to the function of the gaming machine. For example, when the motherboard is operational, the switch may route messages passively. When the motherboard is inoperative, the switch may take control of predetermined functionality. Even when the motherboard is fully operational, the switch may allow remote access to a peripheral device. In some implementations a logic device, such as a programmable logic device, may provide remote access and/or monitoring functions when the motherboard is inoperative.

### FIELD OF THE INVENTION

The present invention relates generally to methods and devices for providing games, such as wagering games.

### BACKGROUND OF THE INVENTION

The network topology on the casino floor and the architectures of individual wager gaming machines evolved dramatically in recent years. Older designs of wager gaming machines rely on a player tracking (PT) module in each gaming machine to serve as a communications gateway between the gaming machine, a card reader and at least one network. The PT module may also support limited security functions such as monitoring switches in contact with various doors, the bill acceptor cashbox, or other sensitive areas of a gaming machine.

In contrast, the newer server-based wager gaming machines may integrate the PT hardware and firmware into the gaming machine's main central processing unit (CPU) board. This board may also be referred to herein as a “motherboard.” If so, the dedicated PT module may be eliminated and the motherboard board itself may now be configured for direct communications with the network or networks. Although current designs for server-based gaming machines represent an improvement over older designs, it would be desirable to further improve gaming machines, as well as related devices and methods.

### SUMMARY OF THE INVENTION

Some wager gaming machines described herein include a switch that has an Internet Protocol (“IP”) address mapping function. The switch may have its own memory for maintaining gaming information, such as security information, state information, configuration parameters, etc. The switch may have embedded security functions that can operate even if a motherboard of the gaming machine is powered down or is otherwise inoperative. The switch may also support multiple communication protocols. The use of alternate protocols may increase functionality beyond that supported by a single communication protocol.

The function of the switch may change according to the function of the gaming machine. For example, when the motherboard is operational, the switch may route messages. When the motherboard is powered off or otherwise inoperative, the switch may take control of predetermined functionality. Even when the motherboard is powered on, the switch may allow direct, remote access to a peripheral device.

Some embodiments include a logic system that includes at least one logic device (such as a processor and/or a programmable logic device), that is configured to provide at least some of the above-described functionality. For example, a logic system may be configured to enable communication between a network and a motherboard. In some such embodiments, the logic system may be configured to provide remote access and/or monitoring functions when the motherboard is powered off or otherwise inoperative. In some embodiments, the switch may support multiple communication protocols.

Some embodiments described herein provide a wager gaming machine. Some such wager gaming machines may include a peripheral system, an interface system, a logic system and a network device. The peripheral system may include the following elements: an input system comprising at least one user input device and at least one credit input device configured for receiving indicia of credit; a display system comprising at least one display device; an audio system; and a credit output system comprising at least one device for dispensing indicia of credit. The interface system may include at least one network interface. The logic system may comprise at least one motherboard processor and may be configured to control the display system and the audio system to provide wagering games according to user input and credit input from the input system. The network device may be configured to do the following: communicate with a network via the interface system; perform Internet Protocol address mapping for network communications; and provide remote access, via the interface system, to at least one peripheral device of the peripheral system when the motherboard processor is inoperative.

The peripheral system may comprise at least one printer. If so, the network device may be configured to allow remote access, via the interface system, to the printer(s) when the motherboard processor is inoperative.

The motherboard may comprise a non-volatile random access memory (“NVRAM”) configured to store wager gaming information. If so, the network device may be configured to allow remote access, via the interface system, to the NVRAM when the motherboard processor is inoperative.

The peripheral system may comprise a card reader that is operable, at least in part, when the motherboard processor is inoperative. The network device may be further configured to transmit information received from such a card reader to another device, via the network interface, when the motherboard processor is inoperative.

The network device may comprise a network device memory configured for maintaining gaming machine information. If so, the network device may be configured to store gaming machine security information, gaming machine state information and/or gaming machine configuration parameters in the network device memory.

The network device may be configured to monitor one or more features of the gaming machine when the motherboard processor is inoperative. For example, the network device may be configured to monitor at least one door of the gaming machine and/or input/output functions of the gaming machine when the motherboard processor is inoperative.

An inoperative state of the motherboard processor may correspond with a powered down state of the motherboard. One or more components of the wager gaming machine may be configured to receive power from an alternative source when the motherboard is powered down. For example, one or more components of the wager gaming machine may be configured to receive power from one or more batteries when the motherboard is powered down. In some embodiments, the network device and/or other component(s) may be configured to receive power via Power Over Ethernet when the motherboard processor is inoperative. The network device may be configured for communication via out-of-band signaling when the motherboard processor is inoperative.

Alternative wager gaming machines are also described herein. Some such wager gaming machines include a peripheral system, an interface system, a logic system and a network device. The peripheral system may include the following components: an input system comprising at least one user input device and at least one credit input device configured for receiving indicia of credit; a display system comprising at least one display device; an audio system; and an credit output system comprising at least one device for dispensing indicia of credit. The interface system may comprise at least one network interface. The logic system may include at least one motherboard processor and may be configured to control the display system and the audio system to provide wagering games according to user input and credit input from the input system. The network device may be configured to do the following: communicate with a network via the interface system; perform Internet Protocol address mapping for network communications; and monitor one or more features of the gaming machine when the motherboard processor is inoperative.

For example, the network device may be configured to monitor at least one door of the gaming machine and/or input/output functions of the gaming machine when the motherboard processor is inoperative. The network device may also be configured to transmit a security communication, via the network interface, when the motherboard processor is inoperative. For example, the security communication may specify a condition of one or more features of the gaming machine.

The peripheral system may comprise a card reader that is operable, at least in part, when the motherboard processor is inoperative. The network device may be further configured to transmit information received from such a card reader to another device, via the network interface, when the motherboard processor is inoperative.

An inoperative state of the motherboard processor may correspond with a powered down state of the motherboard. One or more components of the wager gaming machine may be configured to receive power from an alternative source when the motherboard is powered down. For example, one or more components of the wager gaming machine may be configured to receive power from one or more batteries when the motherboard is powered down. In some embodiments, the network device and/or other component(s) may be configured to receive power via Power Over Ethernet when the motherboard processor is inoperative. The network device may be configured for communication via out-of-band signaling when the motherboard processor is inoperative.

The network device may comprise a network device memory configured for maintaining gaming machine information. If so, the network device may be configured to store gaming machine security information, gaming machine state information and/or gaming machine configuration parameters in the network device memory.

The motherboard may comprise a non-volatile random access memory (“NVRAM”) configured to store wager gaming information. If so, the network device may be configured to allow remote access, via the interface system, to the NVRAM when the motherboard processor is inoperative.

Other wager gaming machine configurations are described herein. Some such wager gaming machines include a peripheral system, an interface system, a motherboard and a logic system. The peripheral system may include the following elements: an input system comprising at least one user input device and at least one credit input device configured for receiving indicia of credit; a display system comprising at least one display device; an audio system; and a credit output system comprising at least one device for dispensing indicia of credit. The interface system may include at least one network interface. The motherboard may include at least one motherboard processor configured to control the display system and the audio system to provide wagering games according to user input and credit input from the input system. The logic system may be configured to enable communications between the motherboard and a network via the interface system and to provide remote access, via the interface system, to at least one peripheral device of the peripheral system when the motherboard is inoperative.

The peripheral system may comprise at least one printer. If so, the network device may be configured to allow remote access, via the interface system, to the printer(s) when the motherboard processor is inoperative.

The motherboard may comprise a non-volatile random access memory (“NVRAM”) configured to store wager gaming information. If so, the network device may be configured to allow remote access, via the interface system, to the NVRAM when the motherboard processor is inoperative.

The peripheral system may comprise a card reader that is operable, at least in part, when the motherboard processor is inoperative. The network device may be further configured to transmit information received from such a card reader to another device, via the network interface, when the motherboard processor is inoperative.

Still other wager gaming machine configurations are described herein. Some such wager gaming machines include a peripheral system, an interface system, a motherboard and a logic system. The peripheral system may include the following elements: an input system comprising at least one user input device and at least one credit input device configured for receiving indicia of credit; a display system comprising at least one display device; an audio system; and an credit output system comprising at least one device for dispensing indicia of credit. The interface system may include at least one network interface. The motherboard may comprise at least one motherboard processor configured to control the display system and the audio system to provide wagering games according to user input and credit input from the input system. The logic system may be configured to enable communications between the motherboard and a network via the interface system and to monitor one or more features of the gaming machine when the motherboard is inoperative.

For example, the network device may be configured to monitor at least one door of the gaming machine and/or input/output functions of the gaming machine when the motherboard processor is inoperative. The network device may also be configured to transmit a security communication, via the network interface, when the motherboard processor is inoperative. For example, the security communication may specify a condition of one or more features of the gaming machine.

The peripheral system may comprise a card reader that is operable, at least in part, when the motherboard is inoperative. The logic system may be further configured to transmit information received from the card reader to another device, via the network interface, when the motherboard is inoperative.

These and other methods of the invention may be implemented by various types of hardware, software, firmware, etc. For example, some features of the invention may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”), random access memory (“RAM”) and various forms of non volatile memory.

### BRIEF DESCRIPTION OF THE DRAWINGS

FIG. 1 is a block diagram that illustrates examples of components for one embodiment.

FIG. 2 is a block diagram that illustrates components that may be used in an alternative embodiment.

FIG. 3 is a flow chart that outlines steps of some methods described herein.

FIG. 4 is a block diagram that illustrates components that may be used in another embodiment.

FIG. 5 is a block diagram that illustrates components that may be used in yet another embodiment.

FIG. 6 is a flow chart that outlines steps of other methods described herein.

FIG. 7 depicts a gaming machine.

FIG. 8 depicts an example of a gaming establishment and related devices that may be used for some implementations described herein.

FIG. 9 illustrates an example of an arbiter and related devices that may be used for some implementations described herein.

FIG. 10 depicts a network device that may be used for some implementations described herein.

### DETAILED DESCRIPTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. For example, the steps of methods shown and described herein are not necessarily performed in the order indicated. It should also be understood that the methods of the invention may include more or fewer steps than are indicated.

Device functionality may be apportioned by grouping or dividing tasks in any convenient fashion. Therefore, when steps are described herein as being performed by a single device, the steps may alternatively be performed by multiple devices and vice versa.

As noted above, server-based (sometimes referred to as “SB” or “sB”) wager gaming machines may integrate PT hardware and firmware into the gaming machine's main CPU board. In some such embodiments, the dedicated PT module used in earlier versions may be eliminated and the main CPU board itself may now be configured for direct communications with one or more networks.

Integrating PT functions into the main CPU board has advantages. For example, IGT's “SB Service Window” enables the gaming machine's primary display and a touchscreen to be used as the PT interface. The touchscreen may be, for example, a liquid crystal display (LCD) touchscreen. This interface is larger than earlier PT interfaces and has better ergonomics. Moreover, this configuration eliminates the cost of a PT specific button panel, touchscreen, speakers and display.

However, networking directly with the gaming machine's motherboard can create issues. For example, an application may arise for which it will be desirable to interface with peripherals contained within the game in a manner that is not supported by the current version of the motherboard and/or its firmware. Such an unsupported application may, for example, be devised following the manufacture and sale of the gaming machine. In principle, it may be possible to revise the gaming machine's hardware or firmware to support such an application. However, it may cost more and take longer to alter, test and obtain regulatory approval for changes to game code and/or hardware which enable the application than it would to bypass the motherboard and instead, interface directly with the peripheral.

For example, an operator may wish to print promotional coupons based upon a data format and content which the motherboard does not support. To address this application, a dual-port printer may be installed in wager gaming machines. One port could be connected to the gaming motherboard whereas the second port could be configured for communication with devices outside the gaming machine. Similarly, it may be desirable for a card reading device to be directly accessible by both the motherboard as well as by devices outside the gaming machine.

However, the Ethernet cable in an SB-configured gaming machine normally connects directly to the gaming machine's motherboard. Therefore, with a prior art gaming machine architecture, an operator would have to route two Ethernet cables into each gaming machine cabinet. Aside from the cost, doubling the amount of cabling and network switches required to support a networked gaming floor would cause more complexity and more logistical difficulties for casino administrators and others.

Networking directly with the gaming machine's main CPU board may also introduce security concerns. Dedicated PT modules typically contain their own, dedicated CPU board and power supply. These features enable the PT module to monitor door and cashbox detection switches even if the gaming machine is powered down or the motherboard is otherwise inoperative. In contrast, if the motherboard is inoperative and the network attaches directly to the motherboard, the ability to detect and report intrusion will be unavailable.

Similarly, if the motherboard is inoperative, it will preclude communications between other game peripherals and devices outside the gaming machine (sometimes referred to herein as ‘remote devices” or the like). However, it may be desirable to communicate with gaming machine peripherals during this time. For example, it may be desirable to perform diagnostics on selected peripherals via. the network Even if a technician is physically present, establishing communications between a gaming machine peripheral and a remote device may be desirable. For example, it would be advantageous to enable communication between a card reader whether or not the gaming machine is powered on, as this would enable technicians to identify themselves and obtain authorization prior opening a gaming machine cabinet.

This application discloses several architectures for wager gaming machines configured for an SB-enabled gaming environment. The architectures described herein provide solutions for the above-described issues.

Some wager gaming machines described herein include a switch that in various embodiments has an IP address mapping function, a source of power which is independent of the main CPU's power, an ability to perform security functions, an ability to independently generate and respond to messages and an ability to support multiple communication protocols)

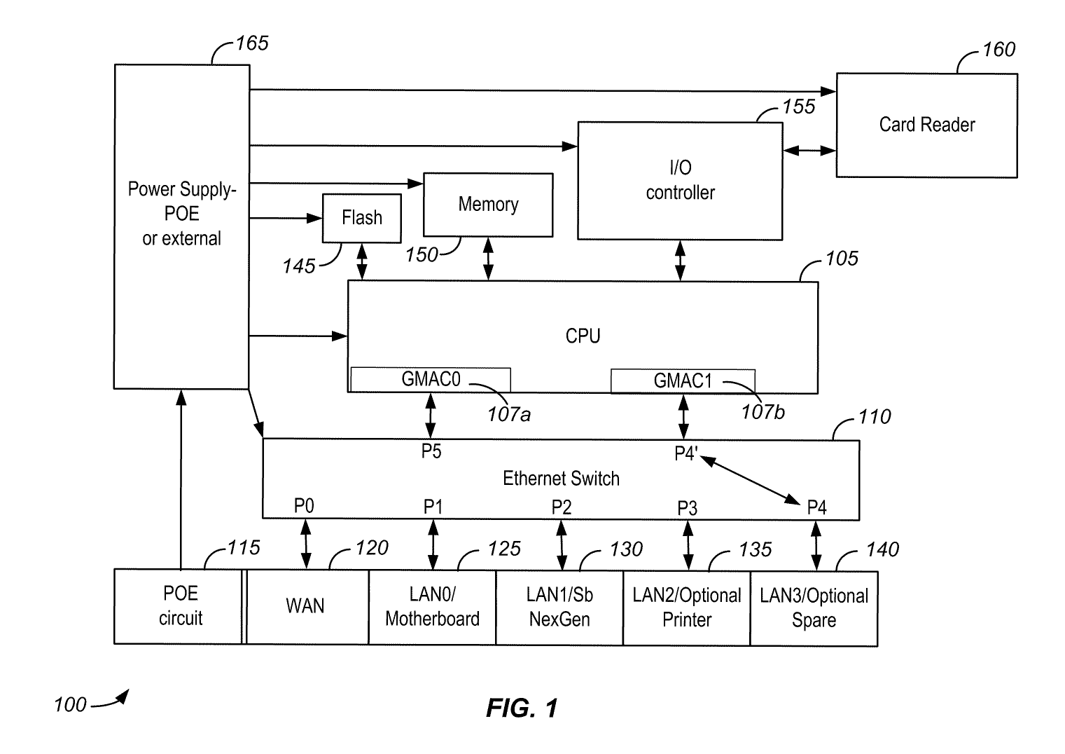

FIG. 1 depicts a portion of electronic gaming machine (EGM) 100 according to one such embodiment. In this example, EGM 100 is configured as a wager gaming machine that is configurable for communication via the Game to System (G2S) protocol. G2S is an Extensible Markup Language (XML) based protocol approved by the Gaming Standards Association which, at present, requires a substantial amount of memory and processing capability. These capabilities are required for the processing of messages required by the protocol. In part because G2S requires a significant amount of computational overhead, EGM 100 includes a logic system, separate from the CPU of the motherboard, to provide at least part of the related processing. Here, the logic system of EGM 100 includes processor 105, which can operate at a rate of at least 600 MHz and that has at least 16 MB of on-chip memory. However, other implementations of EGM 100 may comprise logic devices with more or less computational speed and/or differing amounts of memory.

Similarly, processor 105 is configured for high rates of data transmission. In this instance, processor 105 includes interfaces 107a and 107b that are configurable for transmitting Ethernet frames at a rate of a Gigabit per second or more. For example, interfaces 107a and 107b may be capable of transmitting Ethernet frames according to a 1 Gigabit or a 10 Gigabit Ethernet standard of the Institute of Electrical and Electronics Engineers (“IEEE”), e.g., an IEEE 802.3 standard. Here, each of interfaces 107a and 107b has an associated Gigabit Media Access Controller (“GMAC”), GMAC0 and GMAC1. In other embodiments, processor 105 may have a different number of interfaces and/or interfaces with different capabilities.

EGM 100 includes an internal switch 110, which is a 7-port Ethernet switch in this example. In alternative implementations, switch 110 may include more or fewer ports, e.g., 2 ports, 3 ports, 4 ports, 5 ports, 6 ports, 8 ports, etc. In lower-cost implementations, for example, switch 110 may include may include fewer than 7 ports.

In this example, port P0 is configured for communication with wide area network (“WAN”) 120. WAN 120 may comprise a casino's WAN and/or may comprise the Internet. Switch 110 may distribute communications between WAN 120 and components of EGM 100, e.g., according to Transmission Control Protocol/Internet Protocol (“TCP/IP”). These protocols involve identifying a host using an IP address. When there are multiple computers, such as in an enterprise, each computer will receive a dynamically allocated IP address when it connects to a network.

However, in this example EGM 100 includes an associated Ethernet printer 135 that is configured for communication with port P3 via local area network 2 (“LAN2”). When EGM 100 prints a ticket, a signal may be sent from processor 105 to the IP address associated with the printer 135. In this configuration, processor 105 needs to “know” the IP address associated with printer 135 in order to send the signal to the proper location, even if printer 135 is a component of EGM 100. (The IP address may actually be associated, at least temporarily, with port P3.) Here, port P2 of switch 110 is configured for communication with NexGen® media display 130, which allows a casino operator to communicate with a player of EGM 100 using interactive messaging, animations and stereo sound.

The peripherals and other devices associated with EGM 100 need to be aware of the addresses of other devices associated with EGM 100. This may be implemented in at least two ways. According to one such method, there may be a server that maintains a database of devices and IP addresses. For example, the database may indicate a name for each printer, a name for each motherboard, etc. This server may be configured to resolve that a particular IP address is associated with a particular device (such as a bonus device, a printer, a card reader, a bill acceptor, a motor controller, a speaker or other peripheral device) at a particular location, that another IP address belongs to a another device (such as a motherboard) that may be in the same location, etc. A logic device of the motherboard may be configured to control the printer.

According to some such embodiments, there is a server or other network device on the network that is performing name resolution functionality. Such functionality could be provided by a name server, e.g., a Domain Name System (“DNS”) server. For enterprises that have significant information technology (“IT”) resources (e.g., large casinos), name server implementations may work well.

In some implementations, however, it may be beneficial not to rely on a name server to resolve names, or at least not to rely on a name server as the sole mechanism for resolving names. The name server may malfunction or it may lose communication with the network. The name server's database may not be properly updated.

Accordingly, some implementations may not involve a name server for resolving the IP addresses of those EGM peripherals that have separate addresses, the motherboard, etc. Some such implementations involve relating a Media Access Control (“MAC”) address to an IP address. MAC addresses are unique. Each Ethernet node has a unique MAC address. In some such implementations, switches may route packets based on MAC addresses. However, communications generally use IP addresses, not MAC addresses.

According to some such embodiments, a MAC address table may be stored, such as in a memory device within (or associated with) switch 110. The MAC address table can be examined by a logic device, such as a logic device of switch 110 or by processor 105. The logic device can inform other nodes within EGM 100 what peripherals, etc., have MAC addresses that are associated with EGM 100. The devices having these MAC addresses may be housed within EGM 100. However, these devices are not necessarily inside EGM 100 or even physically attached to EGM 100. Conversely, other peripheral devices may be associated with the motherboard and therefore may be associated with the IP address of the motherboard. Although not illustrated in FIG. 1, some such peripherals are shown and described elsewhere herein.

The MAC address table may be maintained according to various methods. According to some such methods, IP addresses are dynamically allocated, e.g., when EGM 100 powers on. During the dynamic allocation process, not only does processor 105 obtain an IP address, the motherboard and each of the peripherals that communicate via TCP/IP would also obtain IP addresses. For example, EGM 100 may send a DHCPDISCOVER packet (including a source MAC address) to a Dynamic Host Configuration Protocol (“DHCP”) server. The DHCP server will return a dynamically allocated IP address to associate with the source MAC address. Similarly, if a new node boots up (e.g., if a new peripheral such as an auxiliary display is installed), the new node will be assigned an IP address. The switch will update the MAC address table.

In such embodiments, EGM 100 can autonomously make a correlation between MAC addresses and IP addresses, and update a MAC address table accordingly. There is no need for a name server or other network device to make such a correlation, maintain a database of names and IP addresses, etc. In some embodiments, this may be the primary (or only) means for determining IP addresses. However, some implementations may involve both a name server and EGMs that are capable of making a correlation between MAC addresses and IP addresses, updating a MAC address table, etc. In some embodiments, EGM-based address resolution may be a “fall back” option that is implemented if the name server does not work. Although such systems are relatively more complex, they are also more robust.

Another option is to run separate cables to each device that has its own IP address. However this option imposes considerably more cost and complexity. For embodiments that do not involve running a separate cable to each such device, some form of address resolution will be performed, whether by the EGM, by a name server or both.

Given the MAC address of a peripheral or other node, an IP address can be obtained by various methods. One such method is called “inverse ARP.” ARP is the Address Resolution Protocol. According to ARP, an IP address is obtained for a MAC address. During a start-up process involving a plurality of networked computers, every computer on the network will typically go through an ARP process. This is how a DHCP server will dynamically allocate IP addresses.

According to inverse ARP, a MAC address is obtained for an IP address. This presumes that the node already has an IP address. For example, after a DHCP server has assigned an IP address to all active nodes, processor 105 may not immediately be informed of the IP addresses for all of the active nodes of EGM 100. If processor 105 is configured to perform an inverse ARP process, processor 105 may determine the IP addresses for all of its associated and active nodes. For example, processor 105 may send an inverse ARP request to printer 135 via port P3 that indicates, in essence, “I know your MAC address; please reply with your IP address.” A MAC address table may be updated accordingly.

Inverse ARP is not supported by all embodiments. Therefore, alternative embodiments may involve “sniffing” packets to determine a source IP and/or MAC address. For example, switch 110 may send a copy of every packet that comes in from the WAN via port P0 to processor 105, e.g., via port P5. Alternatively, a copy of every packet that comes in from the WAN and has a particular node's destination IP address (e.g., the IP address of printer 135) may be sent to processor 105. Once the packet is captured, its source and destination MAC addresses, source and destination IP addresses, etc., may be determined by processor 105 or another logic device.

Various embodiments provided herein, including EGM 100, include means for providing power to some components even when motherboard 125 is powered down. Here, power supply 165 may provide power to processor 105, switch 110, flash memory 145, memory 150, input/output (“I/O”) controller 155 and/or card reader 160 even when motherboard 125 is powered down. Power supply 165 may, for example, provide power according to Power over Ethernet (PoE), e.g., via PoE circuit 115. Accordingly, power may be provided over a network to components of EGM 100. PoE can supply over 9 Watts, which may be sufficient to drive not only switch 110 but also an auxiliary device, such as card reader 160. Alternatively, or additionally, power supply 165 may comprise a back-up power supply such as a wall pack or “wall wart” transformer, etc.

Accordingly, EGM 100 may provide various types of functionality even when motherboard 125 is powered down or inoperative. For example, switch 110 may have its own memory for maintaining gaming information, such as security information, state information, configuration parameters, etc. Switch 110 may be able to monitor doors, a cash box, attempted access via WAN 120 or other features of EGM 100. Accordingly, switch 110 may have embedded security functions that can operate even if a motherboard of the gaming machine is powered down. In this example, I/O controller 155 provides communications with the card reader, monitors game security (i.e. intrusion detection) and supports storage of selected information in non volatile memory. The I/O controller 155 may provide at least some of this functionality irrespective of the operational status of the motherboard and irrespective of power being applied to the motherboard 125.

The function of switch 110 may change according to the function of the gaming machine. For example, when the motherboard is operational, the switch may route messages passively. When the motherboard is inoperative, the switch may take control of predetermined functionality. For example, when the gaming machine's CPU is not operational, switch itself 110 may respond to selected requests and/or commands arriving at port P0. Switch 110 may monitor at least some conditions of the gaming machine. Switch 110 may generate messages pertaining to events and conditions associated with security functions, non volatile memory and/or the card reader. Accordingly, continuity of security may be maintained whether or not the gaming machine's motherboard is operative.

In most current EGMs, the motherboard communicates with remote devices via. an Ethernet interface while the peripherals, such as a printer, communicate with the motherboard via. a USB interface. If the motherboard is not running for whatever reason, it cannot pass information from a remote device to a peripheral. The motherboard must be operational in order to do this.

However, it may be desirable to communicate with at least some gaming machine peripherals when the CPU board is inoperative, such as for diagnostic purposes. Accordingly, switch 110 may enable remote interrogation and/or control of selected devices associated with EGM 100, even without participation by the gaming machine's CPU. Such communications could be directly exchanged between WAN 120 and printer 135, using switch 110 and ports P0 and P3 respectively.

In some embodiments, switch 110 may also allow remote access to one or more devices of EGM 100 even when motherboard is fully operative. For example, it would be advantageous to enable communication between card reader 160 and a remote device whether or not the gaming machine is powered on, as this would provide a convenient way for technicians to identify themselves and obtain authorization prior opening a gaming machine cabinet, irrespective of the operational status of the gaming machine's motherboard. For example, a technician may wish to open an inoperative EGM in order to diagnose a fault condition. Technicians may first identify themselves by inserting an identity card into the card reader. Data read from the card can then be transmitted to a central server. Once the server establishes that the card belongs to an authorized technician, the server may notify the technician that authorization to open the EGM has been granted by lighting the bezel on the card reader and/or by changing the color of the light. Switch 110 may be able to transfer security and card reader messages between the gaming machine and the network when the gaming machine's CPU is operational yet intercept/redirect messages for the security and/or card reader functions when the gaming machine's CPU is inoperative.

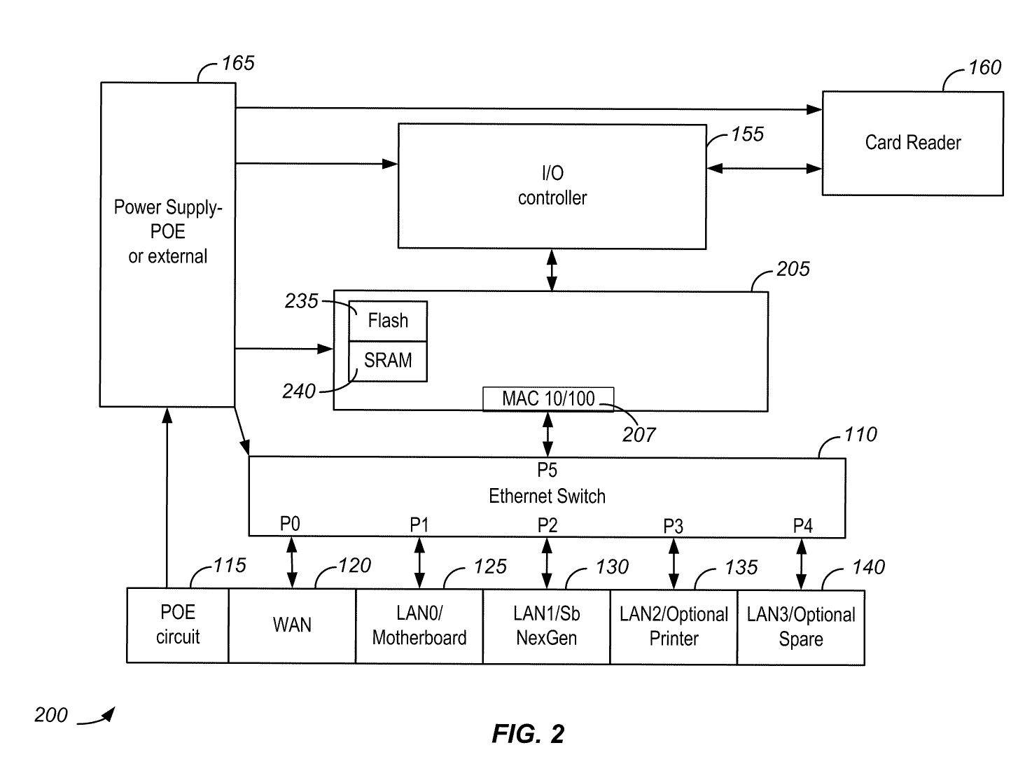

FIG. 2 illustrates components of EGM 200, which is a lower-cost and lower-capability version of the EGM depicted in FIG. 1. EGM 200 includes embedded processor 205, which includes only one interface 207 that is configured for communication with switch 110. In this example, interface 207 supports two different speeds of Ethernet: the two speeds supported are 10BASE-T and 100BASE-TX. Here, processor 205 includes embedded flash memory 235 and random access memory (“RAM”) 240, which is a static RAM (“SRAM”) in this example. A lower cost processor 205 may or may not be fully “G2S capable”: G2S is an evolving standard that will be updated in the future, so the future requirements of G2S are unknown.

Some embodiments provided herein are configured to support the use of more than one protocol. For example, a second protocol may support types of information transfer that are outside of the main communication stream and/or outside of what a main standard currently implements.

In industry, the use of a second protocol may be referred to as ‘out-of-band’ signaling. Some type of out-of-band signaling may be implemented in various communication protocols, including but not limited to SATA (Serial Advanced Technology Attachment), Ethernet, Peripheral Component Interconnect (“PCI”) Express, etc.

For example, out-of-band signaling is used in SATA to establish communications required for the small amount of information that needs to be transferred in order to initialize a link. When a new hard drive is plugged in, there is an out-of-band signaling “handshake” to determine the drive capability (e.g., whether the drive can communicate at 1.5 Gb/sec, 3 Gb/sec or 6 Gb/sec). Only after this out-of-band handshake is completed can the main communication protocol be established. Once the main communication link is fully functional, out-of-band signaling is not required and therefore was not implemented in the prior art. Whatever information was required to be exchanged would be exchanged according to the main protocol, according to the determined capabilities of the devices involved in the communication.

Out-of-band signaling is also used to establish Ethernet communications. When a new device is connected to a network, information is first transferred via out-of-band signaling to determine what kind of connection it is, what is the corresponding device capable of, etc. For example, information is transferred via out-of-band signaling to determine whether the device is configured to operate according to the 10BASE-T standard (at a speed of 10 Mbit/s), according to the 100BASE-TX standard (at a speed of 100 Mbit/s) or according to the 1000BASE-T “Gigabit Ethernet” standard (at a speed of 1 Gbit/s). At this point, Ethernet packets are not yet exchanged: Ethernet packets cannot be exchanged before the speed for packet transmission (and other information) has been established. However, after the Ethernet connection has been established, subsequent communications are made according to the corresponding Ethernet standard, not via out-of-band signaling.

With PCI Express, a similar process occurs. When a connection is first made with a device, information is transferred via out-of-band signaling to determine whether communications will be made according to, e.g., PCI Express version 1, version 2.0 or version 3.0. The communication link also needs to be initialized before the link can be used for communications via PCI Express. In that link, maintenance packets, training packets and other types of packets may be communicated. There are various types of information that need to be established before communication can take place via PCI Express. However, after communications have been established according to the appropriate version of PCI Express, subsequent communications are made according to PCI Express, not by out-of-band signaling.

With respect to electronic gaming machines, it may similarly be desirable to support one or more alternate communication protocols. For example, during periods where the motherboard is powered off or is otherwise inoperative, it may be desirable for the switch to use a communication protocol which runs at a lower speed, requires less processing power and memory than is required to support communications via. the G2S protocol. By running at lower speeds and reducing memory requirements, the hardware costs and power requirements of the switch may be reduced. For example, by reducing power consumption, power for the switch and supporting electronics may be obtained via Power over Ethernet (PoE) during periods when the motherboard is powered off.

Availability of alternate protocols may also serve to implement functions not currently supported by the primary communication protocol. For example, a customer may wish to implement a new printer function. The format of the command to implement a new function may not be understood by the current version of the G2S protocol. In such an instance, it would be desirable to have an alternative protocol available, one which need not entail altering an elaborate protocol such as G2S.

Additionally, an alternate protocol may be desirable as a means to enhance the responsiveness of communications that require expedited communications. For example, the G2S protocol uses the XML language as a basis. Both XML and the G2S protocol built upon XML require extensive processing to parse, interpret and construct messages. The G2S protocol may be further burdened by a requirement that communications be encrypted and decrypted. Such processing requirements may compromise the ability of G2S to promptly handle message exchanges within very brief time frames. Alternate protocols may be better suited for select events which require expedited message handling. For example, the synchronization of multiple gaming machines may require the exchange of messages to occur within a brief, specified time interval.

As previously noted, some EGMs described herein are configured to have some functions enabled that do not require full power. These functions may or may not be related to remote access to the EGM. One would probably not be able to enable all functionality, but one could still enable functions such as those related to security, remote access, etc. For example, the EGM could alert security that someone opened the EGM. This might involve transmitting only a small amount of information.

Returning to the embodiment shown in FIG. 2, when EGM 200 is operational, a message coming over the WAN may be routed transparently to the gaming machine's CPU (in the motherboard, via port P1 and LAN0). There may or may not be interpretation on the part of the embedded processor 205. The message may be, for example, according to G2S or another protocol that requires significant levels of overhead. On the other hand, if the motherboard of EGM 200 is powered off, some level of out-of-band communication may be enabled between the embedded processor 205 and other devices (e.g., with a remote device via WAN 120). However, such communications can probably no longer be made using the G2S protocol. Moreover, such communications can no longer be made with the main CPU of the gaming machine's motherboard.

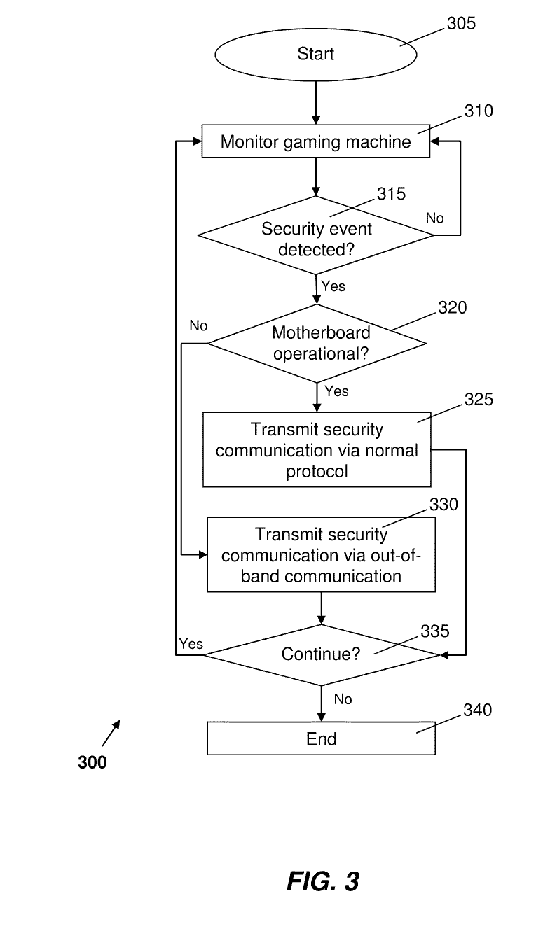

FIG. 3 is a flow chart that outlines the steps of one such method for using out-of-band communication. The process starts in step 305. In step 310, one or more features of a wager gaming machine are monitored. For example, one or more doors, panels, bill validators, etc. of the gaming machine may be monitored by processor 205, I/O controller 155 and/or switch 110 (see FIG. 2). Input/output functions of the gaming machine (e.g., functions of I/O device 155) and/or attempted communications with the gaming machine (e.g., via WAN 120 and port P0) may also be monitored.

If a predetermined event indicating a potential breach of security is detected in step 315, some type of security communication may be transmitted to one or more remote devices. For example, a gaming machine switch may cause a security communication to be transmitted to a network administrator, to one or more devices used by casino security personnel, etc. The security communication may specify a condition of one or more features of the gaming machine. For example, the security communication may indicate a first code corresponding with a “door open” condition, a second code that indicates tampering with a credit output device, a third code that indicates tampering with a cash box, etc.

The protocol used to transmit the security communication may, as in this example, depend on whether the motherboard is powered on and fully operational (as determined in step 320). If so, the security communication may be transmitted according to the protocol normally used for communication between the gaming machine and other devices on the network when the gaming machine is operating normally. (Step 325.) For example, the G2S protocol, IGT's SuperSAS® protocol, the Best of Breed (“BOB”) protocol or another suitable protocol may be used.

However, if the motherboard is inoperative due to either a malfunction or because the main power supply is not currently providing power to the motherboard, the security communication may be transmitted according to an out-of-band communication protocol. (Step 330.)

In step 335, it is determined whether the process will continue. If so, the process reverts back to step 310 and the gaming machine will continue to be monitored. If not, the process ends. (Step 340.)

Although out-of-band communication has been described here with reference to EGM 200, gaming machines having a configuration such as that of EGM 100 may also be configured for out-of-band communication. Moreover, some embodiments include what may be referred to herein as a “logic device”—which may comprise a processor, a programmable logic device, or a similar device—that is configured to provide at least some of the above-described functionality. A logic system may include one or more such logic devices. For example, a logic system may be configured to enable communication between a network and a motherboard. In some such embodiments, the logic system may be configured to provide remote access and/or monitoring functions when the motherboard is powered off.

In some embodiments, the logic system may comprise discrete components such as a microprocessor, a microcontroller and/or a device in which logic is programmed in hardware instead of being stored into memory from which instructions must be fetched and interpreted before execution. In some such embodiments, a logic device may include both a microprocessor and a field programmable gate array (FPGA) incorporated within a single integrated circuit. For example, manufacturers such as Altera, Xilinx and Actel are licensed to incorporate the 32 bit ARM processor core into their FPGA products. Alternative technologies may be substitutes for the FPGA such as a CPLD or Application Specific Integrated Circuit (ASIC).

These devices may be configured to enable communication between a network and a motherboard, between the network and the switch, between the network and select gaming peripherals, and/or between the switch and select gaming peripherals.

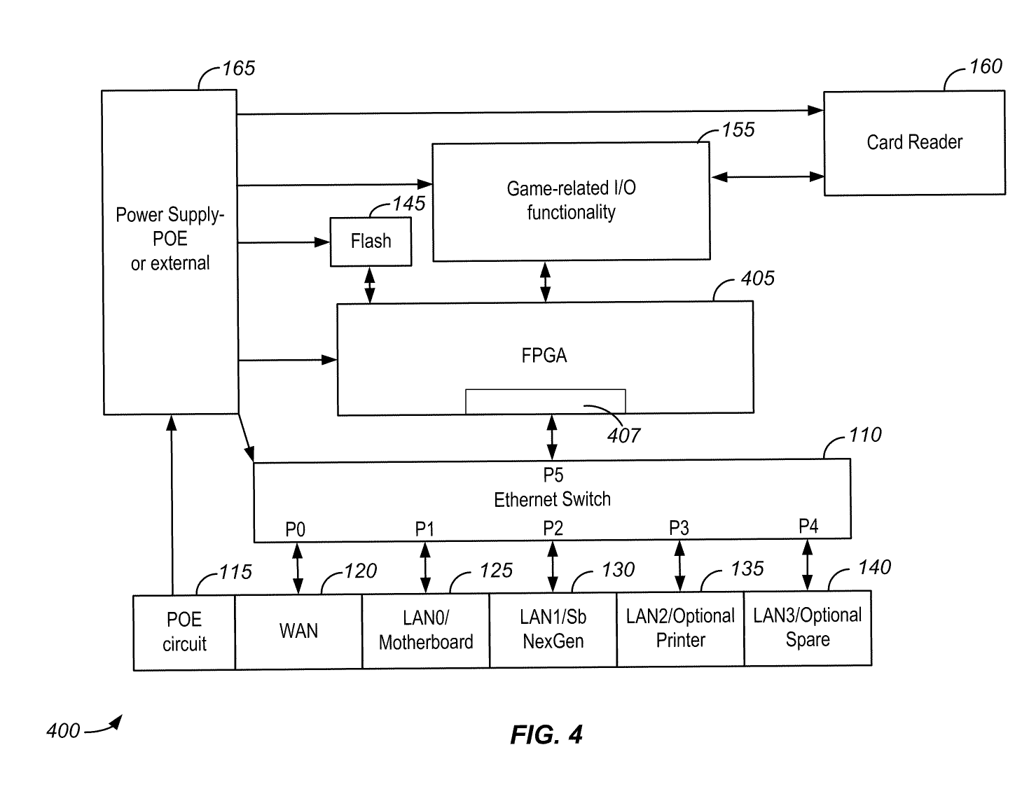

FIG. 4 illustrates one such implementation. FIG. 4 depicts components of EGM 400, which has many of the same components as EGM 100 and EGM 200. Here, however, EGM 400 includes programmable logic device 405 instead of a processor. In this embodiment, programmable logic device 405 is a field-programmable gate array (“FPGA”).

In this example, only one of the switch ports, P5, is in direct communication with the FPGA (via interface 407). However, switch 110 could be configured in many other ways. For example, switch 110 could be configured such that anything that is transmitted on any other port would be mirrored to programmable logic device 405. Alternatively, programmable logic device 405 could be configured to act as a router, such that packets arriving at port P0 from WAN 120 would be transmitted only to programmable logic device 405 via port 5. Programmable logic device 405 could re-transmit the packet to any other destination. Accordingly, programmable logic device 405 could determine where incoming packets would ultimately be sent. Various other routing and switching schemes could be implemented.

In prior art gaming machines, some peripherals, such as a printer, were generally connected directly to the motherboard. In part because of power requirements, such peripherals were typically usable only when the main power supply was powered on and the motherboard was operational.

However, if communications with printer 135 are desired via the network in the configuration shown in FIG. 4, such communications may be directed into port P0 via WAN 120. Switch 110 could send such packets to printer 135 via port P3. If, for example, an owner or administrator wanted to communicate with a printer which does not have its own IP address and is attached to motherboard 125, switch 110 (or programmable logic device 405) could send such packets to motherboard 125 via LAN0. The motherboard could examine the packet, determine that it needs to go to the printer and forward the packet to the printer via a protocol such as RS-232, USB, or IGT's ‘Netplex’ protocol. In this case, the motherboard acts as a gateway.

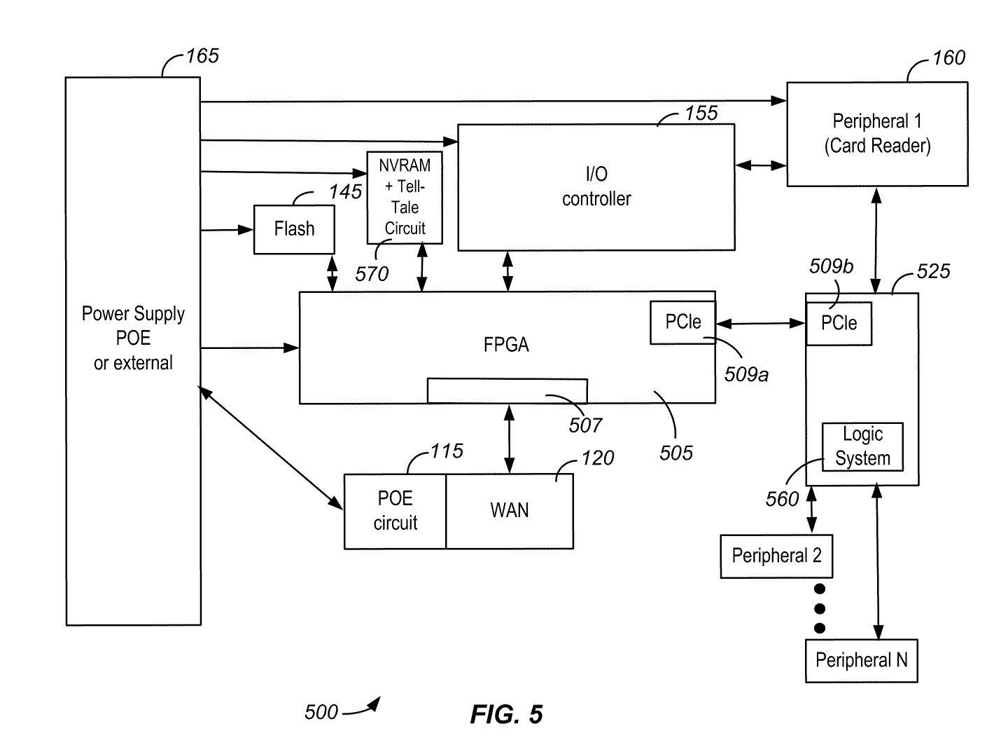

FIG. 5 depicts an alternative and potentially lower-cost implementation without switch 100 and with a different mode of communication between logic device 505 and motherboard 525. In this embodiment of EGM 500, logic device 505 is a programmable logic device 505. Logic device 505 and motherboard 525 communicate via PCI Express interfaces 509a and 509b. In alternative implementations, logic device 505 may be another type of logic device, such as a processor or a logic device with an embedded core processor. Moreover, in other embodiments, logic device 505 and motherboard 525 may communicate via protocols other than PCI Express.

Such embodiments may provide most or all of the remote access, out-of-band communication and/or security features described above. Moreover, such embodiments can also provide remote access to components and peripherals that are attached to motherboard 525, even when logic system 560 of motherboard 525 is powered off.

For example, even if motherboard 525 were switched off and the main power supply were disconnected, one could still remotely access at least peripheral 1 (which is a card reader in this example) and device 570, which includes an NVRAM and a tell-tale circuit in this example. The NVRAM of device 570 retains gaming machine information, including state information, even when the gaming machine's motherboard is powered down. Here, power supply 165 can supply enough power to programmable logic device 505 to allow it to process requests received from a remote device via interface 507 and WAN 120, access gaming machine information from the NVRAM of device 570 and return the requested information to the remote device via interface 507 and WAN 120. Although not shown in FIG. 5, in some embodiments power supply 165 may supply power to motherboard 525 and/or one or more of peripherals 2 through N.

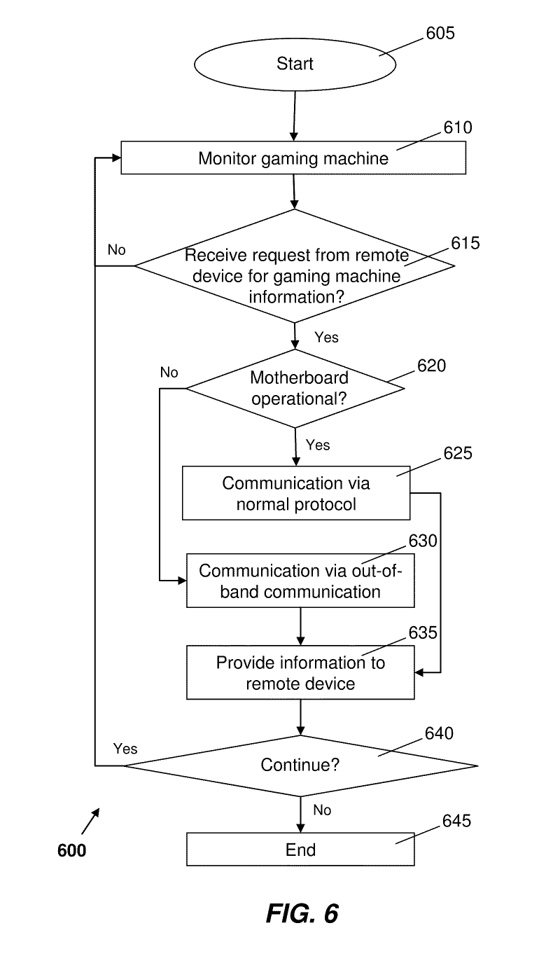

FIG. 6 outlines steps according to some such methods. In step 610, the gaming machine is being monitored. As noted above, various devices could be involved in this function, including logic device 505, logic system 560 and/or I/O controller 155. If the motherboard is powered on and operational, logic device 560 may also be involved in monitoring EGM 500. If a request is received from a remote device for gaming machine information (as determined in step 615), in this example the response will depend on whether the motherboard is operational. (Step 620.)

If the motherboard is operational, communications will be made according to a normal protocol. (Step 625.) For example, logic device 505 and logic system 560 of the motherboard may communicate according to a standard protocol, e.g., via Ethernet over the PCI Express link. Logic device 505 and the remote device may communicate according to TCP/IP, according to a higher level protocol such as G2S, layered atop TCP/IP, or another appropriate protocol.

However, if the motherboard is inoperative, communications will be according to an out-of-band protocol. (Step 630.) Power may be supplied by PoE or by a back-up power supply. Logic device 505 may take over communications and perform out-of-band signaling to obtain the desired information. For example, logic device 505 may query the NVRAM of device 570 and obtain the desired information, such as security information from the tell-tale circuit. In either case, the requested information may be provided to the remote device. (Step 635.)

In step 640, it is determined whether the process will continue. If so, the process reverts back to step 610 and the gaming machine will continue to be monitored. If not, the process ends. (Step 645.)

Returning now to FIG. 5, additional features will be described. The PCI Express link between interfaces 509a and 509b may or may not be a cable. For example, the PCI Express link could be a slot on the motherboard. Programmable logic device 505 could reside on a card that is inserted into the slot. If so, then programmable logic device 505 would be disposed within the secure “brain box” of the gaming machine. Additional security measures may not be required.

However, if the PCI Express link between programmable logic device 505 and motherboard 525 is a cable or the like, the PCI Express link should be secured. Here, the PCI Express link has an associated “tell tale” circuit (in this example, embodied in device 570), such that breaking the PCI Express link would trigger a tell tale indication, such as a security communication sent to another device via interface 507 and WAN 120. The tell-tale circuit would preferably also store a tell tale indication in NVRAM (here, embodied in device 570). The tell-tale circuit may also be configured to monitor one or more door switches, an enclosure that includes a CPU board and/or other components. The tell-tale circuit may be directly wired to these devices in some embodiments.

As noted above, one could provide enough processing power and memory to logic device 505 such that it could also implement the G2S functionality of EGM 100, described with reference to FIG. 1. If logic device 505 were a programmable logic device, this could be an expensive option. However, logic device 505 could have all of the capabilities described above with reference to processor 105 or processor 205.

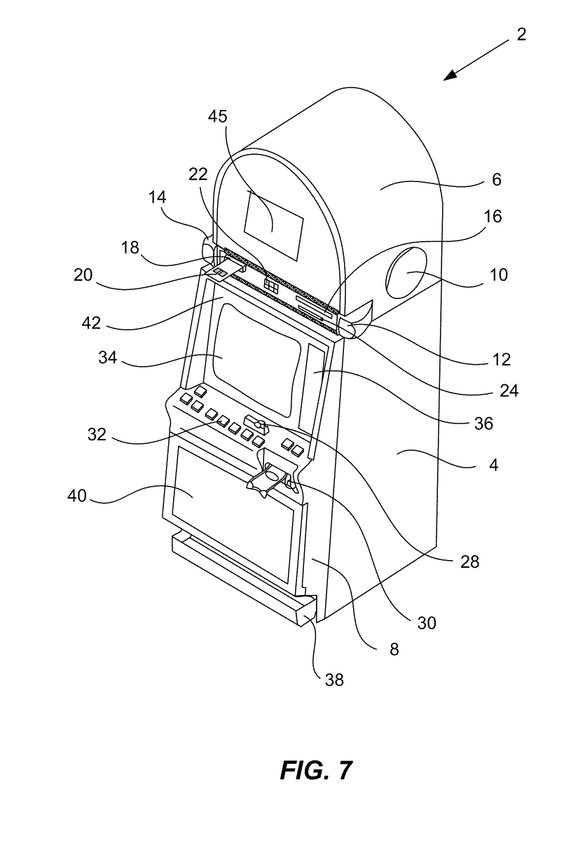

Turning next to FIG. 7, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in FIG. 7. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as IGT gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 7, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Some networks described herein provide methods and devices for managing one or more networked gaming establishments. Such networks may sometimes be referred to herein as server-based gaming networks, Sb™ networks, or the like. Some such gaming networks described herein allow for the convenient provisioning of networked gaming machines and other devices relevant to casino operations. Game themes may be easily and conveniently added or changed, if desired. Related software, including but not limited to player tracking software, peripheral software, etc., may be downloaded to networked gaming machines, mobile gaming devices, thin clients and/or other devices, such as kiosks, networked gaming tables, player stations, etc.

In some implementations, servers or other devices of a central system will determine game outcomes and/or provide other wager gaming functionality. In some such implementations, wagering games may be executed primarily on one or more devices of a central system, such as a server, a host computer, etc. For example, wager gaming determinations (such as interim and final game outcomes, bonuses, etc.) may be made by one or more servers or other networked devices. Player tracking functions, accounting functions and even some display-related functions associated with wagering games may be performed, at least in part, by one or more devices of casino network and/or of a central system.

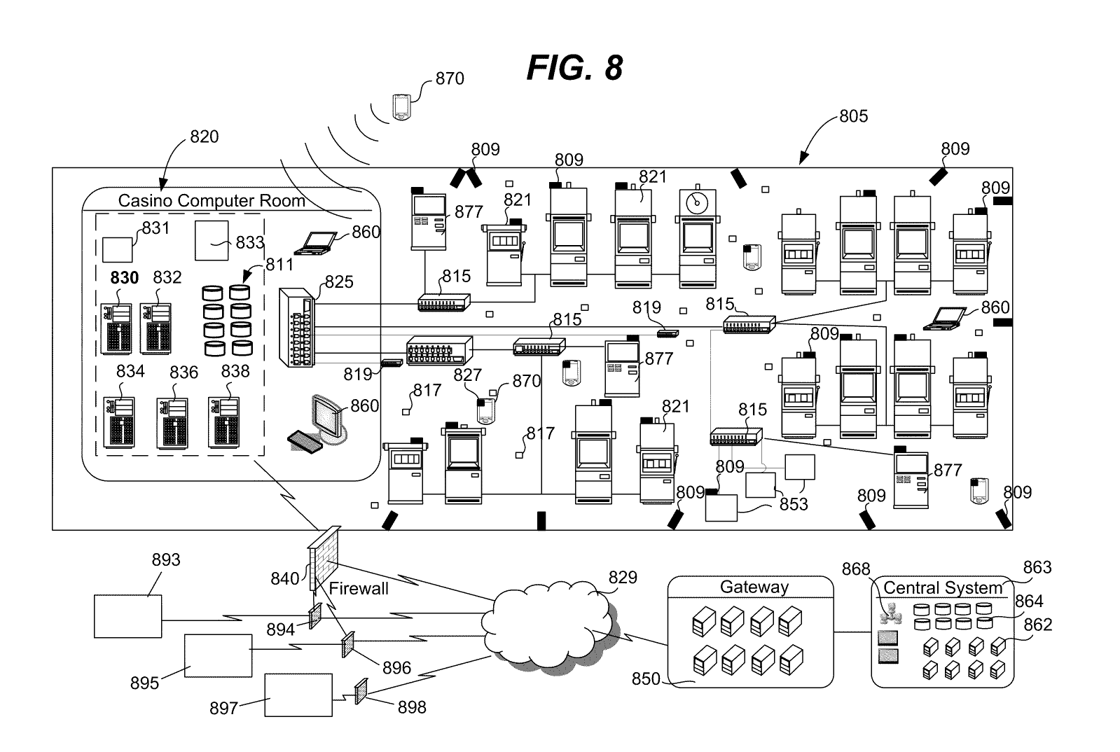

One example of an Sb™ network is depicted in FIG. 8. Those of skill in the art will realize that this architecture and the related functionality are merely examples and that the present invention encompasses many other such embodiments and methods.

Here, casino computer room 820 and networked devices of a gaming establishment 805 are illustrated. Gaming establishment 805 is configured for communication with central system 863 via gateway 850. Gaming establishments 893 and 895 are also configured for communication with central system 863.

In some implementations, gaming establishments may be configured for communication with one another. In this example, gaming establishments 893 and 895 are configured for communication with casino computer room 820. Such a configuration may allow devices and/or operators in casino 805 to communicate with and/or control devices in other casinos. In some such implementations, a server in computer room 820 may control devices in casino 805 and devices in other gaming establishments. Conversely, devices and/or operators in another gaming establishment may communicate with and/or control devices in casino 805.

For example, a server of casino 805 or central system 863 may be provisioned with relatively more advanced software (e.g., 3-D facial recognition software) for patron identification than servers of other networked locations. Such a server may process patron identification requests from devices in casino 805 as well as patron identification requests from devices in gaming establishments 893 and 895.

Here, gaming establishment 897 is configured for communication with central system 863, but is not configured for communication with other gaming establishments. Some gaming establishments (not shown) may not be in communication with other gaming establishments or with a central system. Gaming establishment 805 includes multiple gaming machines 821, each of which is part of a bank 810 of gaming machines 821. In this example, gaming establishment 805 also includes a bank of networked gaming tables 853. However, the present invention may be implemented in gaming establishments having any number of gaming machines, gaming tables, etc. It will be appreciated that many gaming establishments include hundreds or even thousands of gaming machines 821 and/or gaming tables 853, not all of which are necessarily included in a bank and some of which may not be connected to a network. At least some of gaming machines 821 and/or mobile devices 870 may be “thin clients” that are configured to perform client-side methods as described elsewhere herein.

Some gaming networks provide features for gaming tables that are similar to those provided for gaming machines, including but not limited to bonusing, player loyalty/player tracking and the use of cashless instruments. Relevant material is provided in U.S. patent application Ser. No. 11/154,833, entitled “CASHLESS INSTRUMENT BASED TABLE GAME PROMOTIONAL SYSTEM AND METHODOLOGY” and filed on Jun. 15, 2005 (attorney docket no. IGT1P035X3), U.S. Provisional Patent Application No. 60/858,046, entitled “AUTOMATED PLAYER DATA COLLECTION SYSTEM FOR TABLE GAME ENVIRONMENTS” and filed on Nov. 10, 2006 (attorney docket no. IGT1P061X5P), U.S. patent application Ser. No. 11/129,702, entitled “WIDE AREA TABLE GAMING MONITOR AND CONTROL SYSTEM” and filed on May 15, 2005 (attorney docket no. IGT1P115), U.S. patent application Ser. No. 11/425,998 entitled “PROGRESSIVE TABLE GAME BONUSING SYSTEMS AND METHODS”, filed Jun. 22, 2006 (attorney docket no. IGT1P238/P-1049) and U.S. patent application Ser. No. 11/225,299, entitled “UNIVERSAL CASINO BONUSING SYSTEMS AND METHODS” and filed on Sep. 12, 2005 (attorney docket no. IGT1P243), all of which are incorporated herein by reference. Accordingly, software related to such features may be provided and/or controlled, and related data may be obtained and/or provided, according to the present invention.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 853 may be configured for communication with individual player terminals (not shown), which may be configured to accept bets, present an electronic representation of a dealer, indicate game outcomes, etc.

Some gaming networks include electronically configurable tables for playing table games. U.S. patent application Ser. No. 11/517,861, entitled “CASINO DISPLAY METHODS AND DEVICES” and filed on Sep. 7, 2006 (attorney docket no. IGT1P106X2), describes some such tables and is hereby incorporated by reference. An operator may select a desired game, such as a poker game or a blackjack game, and the table will be automatically configured with geometrical patterns, text, etc., which are appropriate for the desired table game. The desired type of table game may be selected by a control on the table itself or according to instructions received from, e.g., a server or a casino manager via a network interface.

Gaming establishment 805 also includes networked kiosks 877. Depending on the implementation, kiosks 877 may be used for various purposes, including but not limited to cashing out, prize redemption, redeeming points from a player loyalty program, redeeming “cashless” indicia such as bonus tickets, smart cards, etc. In some implementations, kiosks 877 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention. For example, in some implementations of the invention, kiosks 877 may be configured to receive information from a patron, e.g., by presenting graphical user interfaces.

In this example, each bank 810 has a corresponding switch 815, which may be a conventional bank switch in some implementations. Each switch 815 is configured for communication with one or more devices in computer room 820 via main network device 825, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 805 also includes an RFID network, implemented in part by RFID switches 819 and multiple RFID readers 817. An RFID network may be used, for example, to track objects (such as mobile gaming devices 870, which include RFID tags 827 in this example), patrons, etc., in the vicinity of gaming establishment 805. Some examples of how an RFID network may be used in a gaming establishment are set forth in U.S. patent application Ser. No. 11/655,496, entitled “DYNAMIC CASINO TRACKING AND OPTIMIZATION” and filed on Jan. 19, 2007 (Attorney Docket No. IGT1P082C1X1/P-713 CON CIP) and in U.S. patent application Ser. No. 11/599,241, entitled “DOWNLOADING UPON THE OCCURRENCE OF PREDETERMINED EVENTS” and filed on Nov. 13, 2006 (Attorney Docket No. IGT1P118C1X1/P-303 CON CIP), all of which are hereby incorporated by reference.

As noted elsewhere herein, some implementations of the invention may involve “smart” player loyalty instruments, such as player tracking cards, which include an RFID tag. Accordingly, the location of such RFID-enabled player loyalty instruments may be tracked via the RFID network. In this example, at least some of mobile devices 870 may include an RFID tag 827, which includes encoded identification information for the mobile device 870. Accordingly, the locations of such tagged mobile devices 870 may be tracked via the RFID network in gaming establishment 805. Other location-detection devices and systems, such as the global positioning system (“GPS”), may be used to monitor the location of people and/or devices in the vicinity of gaming establishment 805 or elsewhere.

Various alternative network topologies can be used to implement different aspects of the invention and/or to accommodate varying numbers of networked devices. For example, gaming establishments with large numbers of gaming machines 821 may require multiple instances of some network devices (e.g., of main network device 825, which combines switching and routing functionality in this example) and/or the inclusion of other network devices not shown in FIG. 8. Some implementations of the invention may include one or more middleware servers disposed between kiosks 877, RFID switches 819 and/or bank switches 815 and one or more devices in computer room 820 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 811, Sb™ server 830, License Manager 831, Arbiter 833, servers 832, 834, 836 and 838, host device(s) 860 and main network device 825 are disposed within computer room 820 of gaming establishment 805. In practice, more or fewer devices may be used. Depending on the implementation, some such devices may reside in gaming establishment 805 or elsewhere.

One or more devices in central system 863 may also be configured to perform, at least in part, tasks specific to the present invention. For example, one or more servers 862, arbiter 833, storage devices 864 and/or host devices 860 of central system 863 may be configured to implement the functions described in detail elsewhere herein. These functions may include, but are not limited to, processing security-related communications, providing (at least in part) remote access to gaming machine information, providing PoE to a gaming machine, etc.

One or more of the servers of computer room 820 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 809, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 820 to mobile devices 870. Some implementations of the present invention include a plurality of networked cameras 809, which may be video cameras, smart cameras, digital still cameras, etc. In some such implementations, such cameras may provide, at least in part, real-time navigation features such as those described in U.S. patent application Ser. No. 12/106,771 (attorney docket no. IGT1P410/P-1222), entitled “Real-Time Navigation Devices, Systems and Methods,” which is incorporated herein by reference.

Other devices that may be deployed in network 805 do not appear in FIG. 8. For example, some gaming networks may include not only various radio frequency identification (“RFID”) readers 817, but also RFID switches, middleware servers, etc., some of which are not depicted in FIG. 8. These features may provide various functions. For example, a server (or another device) may determine a location of a mobile device 870 according to the location of an RFID reader that reads an RFID tag 827.

The servers and other devices indicated in FIG. 8 may be configured for communication with other devices in or outside of gaming establishment 805, such as host devices 860, kiosks 877 and/or mobile devices 870, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of Sb™ server 830 and the other servers shown in FIG. 8 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 831, servers 832, 834, 836 and 838, and main network device 825) are mounted in a single rack with Sb™ server 830. Accordingly, many or all such devices will sometimes be referenced in the aggregate as an “Sb™ server.” However, in alternative implementations, one or more of these devices is in communication with Sb™ server 830 and/or other devices of the network but located elsewhere. For example, some of the devices could be mounted in separate racks within computer room 820 or located elsewhere on the network. Moreover, it can be advantageous to store large volumes of data elsewhere via a storage area network (“SAN”).

Computer room 820 may include one or more operator consoles or other host devices that are configured for communication with other devices within and outside of computer room 820. Such host devices may be provided with software, hardware and/or firmware for implementing various aspects of the invention. However, such host devices need not be located within computer room 820. Wired host devices 860 (which are desktop and laptop computers in this example) and wireless devices 870 (which are PDAs in this example) may be located elsewhere in gaming establishment 805 or at a remote location.

Some embodiments of the invention include devices for implementing access control, security and/or other functions relating to the communication between different devices on the network. In this example, arbiter 833 serves as an intermediary between different devices on the network. Arbiter 833 may be implemented, for example, via software that is running on a server or another networked device. Some implementations of Arbiter 833 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 833 is a repository for the configuration information required for communication between devices on the gaming network (and, in some implementations, devices outside the gaming network). Although Arbiter 833 can be implemented in various ways, one exemplary implementation is discussed in the following paragraphs.

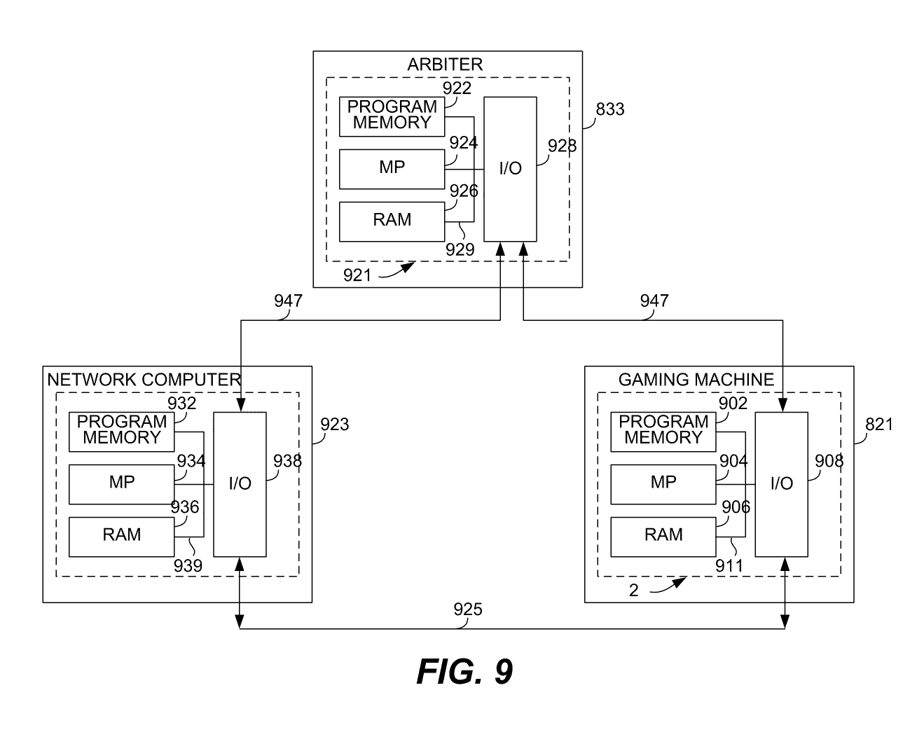

FIG. 9 is a block diagram of a simplified communication topology between gaming machine 821, network computer 923 and Arbiter 833. Network computer 923 may be, for example, a server or other device within computer room 820 or elsewhere. Although only one gaming machine 821, one network computer 923 and one Arbiter 833 are shown in FIG. 9, it should be understood that the following examples may be applicable to different types of networked devices in addition to gaming machine 821 and network computer 923, and may include different numbers of network computers 923, Arbiters 833 and gaming machines 821. For example, a single Arbiter 833 may be used for secure communications among a plurality of network computers 923 and tens, hundreds or thousands of gaming machines 821. Likewise, multiple Arbiters 833 may be utilized for improved performance and other scalability factors.

Referring to FIG. 9, the Arbiter 833 may include an arbiter controller 921 that may comprise a program memory 922, a microcontroller or microprocessor (MP) 924, a random-access memory (RAM) 926 and an input/output (I/O) circuit 928, all of which may be interconnected via an address/data bus 929. The network computer 923 may also include a controller 931 that may comprise a program memory 932, a microcontroller or microprocessor (MP) 934, a random-access memory (RAM) 936 and an input/output (I/O) circuit 938, all of which may be interconnected via an address/data bus 939. It should be appreciated that although the Arbiter 833 and the network computer 923 are each shown with only one microprocessor 924, 934, the controllers 921, 931 may each include multiple microprocessors 924, 934. Similarly, the memory of the controllers 921, 931 may include multiple RAMs 926, 936 and multiple program memories 922, 932. Although the I/O circuits 928, 938 are each shown as a single block, it should be appreciated that the I/O circuits 928, 938 may include a number of different types of I/O circuits. The RAMs 924, 934 and program memories 922, 932 may be implemented as semiconductor memories, magnetically readable memories, and/or optically readable memories, for example.

Although the program memories 922, 932 are shown in FIG. 9 as read-only memories (ROM) 922, 932, the program memories of the controllers 921, 931 may be a read/write or alterable memory, such as a hard disk. In the event a hard disk is used as a program memory, the address/data buses 929, 939 shown schematically in FIG. 9 may each comprise multiple address/data buses, which may be of different types, and there may be an I/O circuit disposed between the address/data buses.

As shown in FIG. 9, the gaming machine 821 may be operatively coupled to the network computer 923 via the data link 925. The gaming machine 821 may also be operatively coupled to the Arbiter 833 via the data link 949, and the network computer 923 may likewise be operatively coupled to the Arbiter 833 via the data link 947.

Communications between the gaming machine 821 and the network computer 923 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 833 may verify the authenticity of devices in the gaming network, including but not limited to devices sending queries and/or remote procedure calls to gaming machines. The Arbiter 833 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 833 may provide encryption keys (session keys) for the communication session to the client via the secure communication channel. Either the host and/or the session key may be provided in response to the request, or may have been previously provided. The client may contact the host to initiate the communication session. The host may then contact the Arbiter 833 to determine the authenticity of the client. The Arbiter 833 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 833 may contact the host regarding the request and provide corresponding session keys to both the client and the host. The Arbiter 833 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Referring again to FIG. 8, the communication link(s) between casino 805 and central system 863 preferably have ample bandwidth and may, for example, comprise one or more T1 or T3 connections and/or satellite links having comparable bandwidth, etc. Network 829 is the Internet in this example. However, it will be understood by those of skill in the art that network 829 could include any one of various types of networks, such as the public switched telephone network (“PSTN”), a satellite network, a wireless network, a metro optical transport, etc. Accordingly, a variety of protocols may be used for communication on network 829, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 805 and the outside world should only be made with trusted devices via a secure link, e.g., via a virtual private network (“VPN”) tunnel. For example, the illustrated connection between Sb™ server 830, gateway 850 and central system 863 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

Alternatively, a permanent virtual circuit (“PVC”) can be established to provide a dedicated and secure circuit link between two facilities, e.g., between a casino and central system 863. A PVC is a virtual circuit established for repeated use between the same data terminals. A PVC could be provided, for example, via AT&T's Asynchronous Transfer Mode (“ATM”) switching fabric. Some implementations provide a dedicated line from an endpoint (e.g., from casino 805) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 805 and central system 863, allows for the deployment of many advantageous features. For example, a customer (e.g., an employee of a gaming establishment) may be able to log onto an account of central system 863 to obtain the account information such as the customer's current and prior account status. Automatic updates of a customer's software may also be enabled. For example, central system 863 may notify one or more devices in gaming establishment 805 regarding new products and/or product updates. For example, central system 863 may notify server (or other device) in computer room 820 regarding new software, software updates, the status of current software licenses, etc. Alternatively, such updates could be automatically provided to a server in computer room 820 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 863, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 863 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

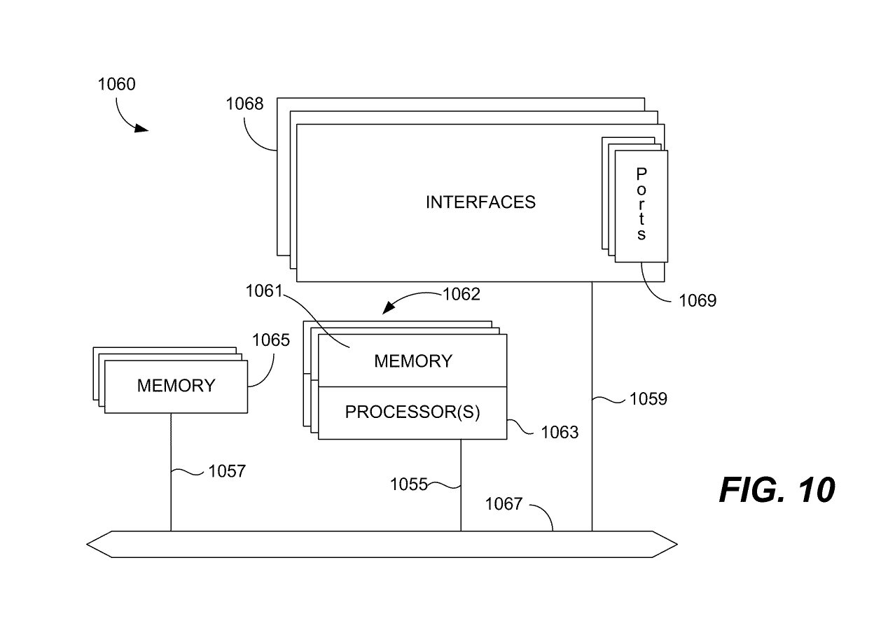

FIG. 10 illustrates an example of a network device that may be configured for implementing some methods of the present invention. Network device 1060 includes a master central processing unit (CPU) 1062, interfaces 1068, and a bus 1067 (e.g., a PCI bus). Generally, interfaces 1068 include ports 1069 appropriate for communication with the appropriate media. In some embodiments, one or more of interfaces 1068 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1068 control such communications-intensive tasks as encryption, decryption, compression, decompression, packetization, media control and management. By providing separate processors for the communications-intensive tasks, interfaces 1068 allow the master microprocessor 1062 efficiently to perform other functions such as routing computations, network diagnostics, security functions, etc.

The interfaces 1068 are typically provided as interface cards (sometimes referred to as “linecards”). Generally, interfaces 1068 control the sending and receiving of data packets over the network and sometimes support other peripherals used with the network device 1060. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1062 may be responsible for implementing specific functions associated with the functions of a desired network device. According to some embodiments, CPU 1062 accomplishes all these functions under the control of software including an operating system and any appropriate applications software.

CPU 1062 may include one or more processors 1063 such as a processor from the Motorola family of microprocessors or the MIPS family of microprocessors. In an alternative embodiment, processor 1063 is specially designed hardware for controlling the operations of network device 1060. In a specific embodiment, a memory 1061 (such as non-volatile RAM and/or ROM) also forms part of CPU 1062. However, there are many different ways in which memory could be coupled to the system. Memory block 1061 may be used for a variety of purposes such as, for example, caching and/or storing data, programming instructions, etc.

Regardless of network device's configuration, it may employ one or more memories or memory modules (such as, for example, memory block 1065) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 10 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 10) or switch fabric based (such as a cross-bar).

The above-described devices and materials will be familiar to those of skill in the gaming industry and/or in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

We claim:

1. A wager gaming machine, comprising:
a peripheral system comprising:
an input system comprising at least one user input device and at least one credit input device configured for receiving indicia of credit;
a display system comprising at least one display device;
an audio system; and
a credit output system comprising at least one device for dispensing indicia of credit;
an interface system comprising at least one network interface;
a logic system comprising at least one motherboard processor, the logic system configured to control the display system and the audio system to provide wagering games according to user input and credit input from the input system; and
a network device configured to do the following:
communicate with a network via the interface system;
perform Internet Protocol address mapping for network communications; and
provide remote access, via the interface system, to at least one peripheral device of the peripheral system when the motherboard processor is inoperative.

2. The wager gaming machine of claim 1, wherein the peripheral system comprises at least one printer and wherein the network device is configured to allow remote access, via the interface system, to the at least one printer when the motherboard processor is inoperative.

3. The wager gaming machine of claim 1, wherein the motherboard comprises a non-volatile random access memory (“NVRAM”) configured to store wager gaming information and wherein the network device is configured to allow remote access, via the interface system, to the NVRAM when the motherboard processor is inoperative.

4. The wager gaming machine of claim 1, wherein the peripheral system comprises a card reader that is operable, at least in part, when the motherboard processor is inoperative, and wherein the network device is further configured to transmit information received from the card reader to another device, via the network interface, when the motherboard processor is inoperative.

5. The wager gaming machine of claim 1, wherein the network device comprises a network device memory for maintaining gaming machine information.

6. The wager gaming machine of claim 1, wherein the network device is configured to monitor one or more features of the gaming machine when the motherboard processor is inoperative.

7. The wager gaming machine of claim 1, wherein the network device is configured to receive power via Power Over Ethernet when the motherboard processor is inoperative.

8. The wager gaming machine of claim 1, wherein the network device is configured for communication via out-of-band signaling when the motherboard processor is inoperative.

9. The wager gaming machine of claim 1, wherein an inoperative state of the motherboard processor corresponds with a powered down state of the motherboard.

10. The wager gaming machine of claim 5, wherein the network device is configured to store gaming machine security information in the network device memory.

11. The wager gaming machine of claim 5, wherein the network device is configured to store gaming machine state information in the network device memory.

12. The wager gaming machine of claim 5, wherein the network device is configured to store gaming machine configuration parameters in the network device memory.

13. The wager gaming machine of claim 6, wherein the network device is configured to monitor at least one door of the gaming machine when the motherboard processor is inoperative.

14. The wager gaming machine of claim 6, wherein the network device is configured to monitor input/output functions of the gaming machine when the motherboard processor is inoperative.

15. A wager gaming machine, comprising:
a peripheral system comprising:
an input system comprising at least one user input device and at least one credit input device configured for receiving indicia of credit;
a display system comprising at least one display device;
an audio system; and
a credit output system comprising at least one device for dispensing indicia of credit;
an interface system comprising at least one network interface;
a logic system comprising at least one motherboard processor, the logic system configured to control the display system and the audio system to provide wagering games according to user input and credit input from the input system; and
a network device configured to do the following:
communicate with a network via the interface system;
perform Internet Protocol address mapping for network communications; and
monitor one or more features of the gaming machine when the motherboard processor is inoperative.

16. The wager gaming machine of claim 15, wherein the network device is configured to monitor at least one door of the gaming machine when the motherboard processor is inoperative.

17. The wager gaming machine of claim 15, wherein the network device is configured to monitor input/output functions of the gaming machine when the motherboard processor is inoperative.

18. The wager gaming machine of claim 15, wherein the network device is configured to transmit a security communication, via the network interface, when the motherboard processor is inoperative.

19. The wager gaming machine of claim 15, wherein the peripheral system comprises a card reader that is operable, at least in part, when the motherboard processor is inoperative, and wherein the network device is further configured to transmit information received from the card reader to another device, via the network interface, when the motherboard processor is inoperative.

20. The wager gaming machine of claim 15, wherein an inoperative condition of the motherboard processor comprises a powered down condition of the motherboard.

21. The wager gaming machine of claim 18, wherein the security communication specifies a condition of one or more features of the gaming machine.

22. A wager gaming machine, comprising:
a peripheral system comprising:
an input system comprising at least one user input device and at least one credit input device configured for receiving indicia of credit;
a display system comprising at least one display device;
an audio system; and
a credit output system comprising at least one device for dispensing indicia of credit;
an interface system comprising at least one network interface;
a motherboard comprising at least one motherboard processor configured to control the display system and the audio system to provide wagering games according to user input and credit input from the input system; and
a logic system comprising at least one logic device and configured to do the following:
enable communications between the motherboard and a network via the interface system; and
provide remote access, via the interface system, to at least one peripheral device of the peripheral system when the motherboard is inoperative.

23. The wager gaming machine of claim 22, wherein the motherboard further comprises a non-volatile random access memory (“NVRAM”) configured to store wager gaming information and wherein the logic system is configured to allow remote access, via the interface system, to the NVRAM when the motherboard is inoperative.

24. The wager gaming machine of claim 22, wherein the peripheral system comprises at least one printer and wherein the logic system is configured to allow remote access, via the interface system, to the at least one printer when the motherboard is inoperative.

25. The wager gaming machine of claim 22, wherein the peripheral system comprises a card reader that is operable, at least in part, when the motherboard is inoperative, and wherein the logic system is further configured to transmit information received from the card reader to another device, via the network interface, when the motherboard is inoperative.

26. A wager gaming machine, comprising:
a peripheral system comprising:
an input system comprising at least one user input device and at least one credit input device configured for receiving indicia of credit;
a display system comprising at least one display device;
an audio system; and
a credit output system comprising at least one device for dispensing indicia of credit;
an interface system comprising at least one network interface;
a motherboard comprising at least one motherboard processor configured to control the display system and the audio system to provide wagering games according to user input and credit input from the input system; and
a logic system comprising at least one logic device and configured to do the following:
enable communications between the motherboard and a network via the interface system; and
monitor one or more features of the gaming machine when the motherboard is inoperative.

27. The wager gaming machine of claim 26, wherein the logic system is configured to monitor at least one door of the gaming machine when the motherboard is inoperative.

28. The wager gaming machine of claim 26, wherein the logic system is configured to monitor input/output functions of the gaming machine when the motherboard is inoperative.

29. The wager gaming machine of claim 26, wherein the logic system is configured to transmit a security communication, via the network interface, when the motherboard is inoperative.

30. The wager gaming machine of claim 26, wherein the peripheral system comprises a card reader that is operable, at least in part, when the motherboard is inoperative, and wherein the logic system is further configured to transmit information received from the card reader to another device, via the network interface, when the motherboard is inoperative.

31. The wager gaming machine of claim 29, wherein the security communication specifies a condition of one or more features of the gaming machine.
